(19) United States
(12) Patent Application Publication
(10) Pub. No.: US 2024/0281677 A1
(43) Pub. Date: Aug. 22, 2024

(54) Systems and Methods for Creating an Interactive Knowledge Base Using Interactive Chat Machine Learning Models

(71) Applicant: STATE FARM MUTUAL AUTOMOBILE INSURANCE COMPANY, Bloomington, IL (US)

(72) Inventor: Matthew Mifflin, Bloomington, IL (US)

(21) Appl. No.: 18/242,719

(22) Filed: Sep. 6, 2023

Related U.S. Application Data
(60) Provisional application No. 63/453,307, filed on Mar. 20, 2023.
(60) Provisional application No. 63/447,864, filed on Feb. 23, 2023.
(60) Provisional application No. 63/485,741, filed on Feb. 17, 2023.

(51) Int. Cl. G06N 5/04; G06N 5/022

(52) U.S. Cl. CPC G06N 5/04; G06N 5/022

(57) ABSTRACT

Systems and methods for creating an interactive knowledge base are disclosed herein. An exemplary computer-implemented method may include connecting a training module configured to train a machine learning (ML) chatbot to a communication channel associated with the communication system. The exemplary method further includes aggregating, by executing the training module, a set of data corresponding to the communication system from a plurality of communications utilizing the communication channel. The exemplary method further includes training the ML chatbot with the set of data corresponding to the communication system as inputs to generate a plurality of training responses as outputs, wherein the plurality of training responses represent responses to hypothetical prompts related to the data corresponding to the communication system; and connecting the ML chatbot to one or more live communication channels of the communication system to generate predicted responses to live prompts received across the one or more live communication channels.

### CROSS-REFERENCE TO RELATED APPLICATIONS

This application claims priority to U.S. Provisional Patent Application No. 63/453,307, entitled “Systems and Methods for Creating an Interactive Knowledge Base Using Interactive Chat Machine Learning Models,” filed on Mar. 20, 2023, U.S. Provisional Patent Application No. 63/447,864, entitled “Systems and Methods for Creating an Interactive Knowledge Base Using Interactive Chat Machine Learning Models,” filed on Feb. 23, 2023, and to U.S. Provisional Patent Application No. 63/485,741, entitled “Techniques for Improving Communication Processing Through Interactive Chat Machine Learning Models,” filed on Feb. 17, 2023, the disclosures of each of which are hereby incorporated herein by reference.

### TECHNICAL FIELD

The present disclosure generally relates to systems and methods for monitoring communication system activity, and more particularly, to creating an interactive knowledge base using interactive chat machine learning models, such as machine learning-based chatbots/voice bots.

### BACKGROUND

Generally speaking, communication systems may involve a variety of components operating together to perform various communication operations. These systems, and the corresponding operations, may be incredibly complex, and may require significant knowledge and experience to maintain steady, reliable performance and/or to provide accurate, relevant information to those requesting information regarding such systems. In fact, system users/operators conventionally may spend years accumulating the necessary body of knowledge and/or experience required to serve as a “subject matter expert” related to one component/subsystem of a larger communication system.

Accordingly, these conventional techniques may generally suffer from a lack of rapid and broad knowledge accumulation. In particular, conventional techniques may not provide rapid access to communication system information because the conventional subject matter experts have limited available time, and may not always recall the relevant information and/or the location of such information quickly. These conventional techniques may also suffer from a lack of broad-based knowledge, as the conventional subject matter experts may not have a knowledge base that extends beyond their individual subject matter area. Thus, in many circumstances, conventional subject matter experts may provide information to a user/operator that is untimely and/or of otherwise limited value due to the relatively limited scope of the subject matter expert's own knowledge base.

As a result, these conventional techniques may frequently leave individual users/operators to aimlessly sift through large reams of technical information/documentation in an effort to find answers to their questions related to the communication system component/subsystem and/or underlying services/goods utilizing the communication system (e.g., a consumer goods/services customer service communication system). These individual users/operators may ultimately identify irrelevant, outdated, and/or otherwise inaccurate information, and may proceed to act based on such inaccurate information, which may lead to significant mistakes, erroneous actions, wasted time and computing resources, and/or other issues. Consequently, conventional techniques may provide non-optimal solutions for efficiently operating, maintaining, and/or otherwise interacting with a communication system by lacking a centralized, robust knowledge base.

Therefore, in general, creating an interactive knowledge base for a communication system may be an area of great interest, and conventional techniques may be insufficient for providing such interactive knowledge base creation. Accordingly, a need exists for systems and methods for creating an interactive knowledge base using interactive chat machine learning models to provide communication system users/operators with accurate, relevant information that may mitigate the negative effects stemming from a lack of such nuanced, readily available information. Conventional techniques may include additional inefficiencies, ineffectiveness, encumbrances, and/or other drawbacks as well.

### SUMMARY

Conventionally, call/chat agents may struggle with an inability to quickly understand a customer's question/complaint and respond in a meaningful way. As previously mentioned, conventional subject matter experts that may be able to help these call/chat agents may not provide useable/timely information for a variety of reasons. However, many/most of these questions/complaints may either have established answers or may rely on principles referenced in the universe of known answers/solutions. Thus, to solve these issues, the systems of the present disclosure may train a machine learning chatbot to serve as a permanent “subject matter expert” that may field live questions from customers/users and agents.

In particular, the systems of the present disclosure may transmit customer/agent questions (or derivations thereof) to the machine learning chatbot to generate response templates that may help agents quickly interpret and answer the customer's/agent's questions. The system may train the machine learning chatbot with live communications (e.g., voice, text, etc.) from customers and agents, live communications between/among agents or other internal communication system personnel, question and answer (Q&A) documents, frequently asked questions (FAQ) documents, internal memos/information documents, communication system team emails/communications, and/or any other suitable information. In this manner, the machine learning chatbot may automatically provide answers to common questions and/or form answers to questions that require information from multiple, disparate sources that an agent may not normally find and/or recall quickly.

In certain embodiments, the system may also transmit text or other data from internal team calls/chats to the machine learning chatbot so that the model may slowly build a knowledge base for real-time applications during interfaces with customers. Additionally, or alternatively, the machine learning chatbot may be trained to retrieve and/or otherwise utilize customer profile data for a customer to customize the generated response (e.g., how a particular customer prefers to consume information, such as via text, phone call, email, webchat, etc.).

In certain embodiments, the system may be or include a communication system configured to receive communications from external users, route the external users to an appropriate subsystem (e.g., connect the user to a live agent, transmit communications to an automated response subsystem) within the communication system for processing, and process those communications. Of course, it should be appreciated that the system may be any suitable system in which updates may be received and/or processed.

One exemplary embodiment of the present disclosure may be a computer-implemented method for creating an interactive knowledge base in a communication system. The computer-implemented method may be implemented via one or more local or remote processors, servers, sensors, transceivers, mobile devices, wearables, smart watches, smart contact lenses, voice bots, chat bots, ChatGPT bots, smart glasses, augmented reality glasses, virtual reality headsets, mixed or extended reality headsets or glasses, and other electronic or electrical components, which may be in wired or wireless communication with one another. For example, in one instance, the method may include: (1) connecting, by one or more processors, a training module configured to train a machine learning (ML) chatbot to a communication channel associated with the communication system, wherein the communication channel transmits data corresponding to the communication system; (2) aggregating, by the one or more processors executing the training module, a set of data corresponding to the communication system from a plurality of communications utilizing the communication channel; (3) training, by the one or more processors executing the training module, the ML chatbot with the set of data corresponding to the communication system as inputs to generate a plurality of training responses as outputs, wherein the plurality of training responses represent responses to hypothetical prompts related to the data corresponding to the communication system; and/or (4) connecting, by the one or more processors, the ML chatbot to one or more live communication channels of the communication system to generate predicted responses to live prompts received across the one or more live communication channels. The method may include additional, less, or alternate functionality and actions, including those discussed elsewhere herein.

For instance, in a variation of this embodiment, the method may further include: connecting, by the one or more processors, a user to a live agent across a first communication channel to which the ML chatbot is connected; receiving, at the one or more processors, a user query from the user; and/or generating, by the one or more processors executing the ML chatbot, a predicted response to the user query, wherein the predicted response includes a citation to a first piece of data from the set of data. Further in this variation, generating the predicted response may further include: generating, by the one or more processors, one or more embeddings associated with the user query; comparing, by the one or more processors, the one or more embeddings to a library of embeddings; and/or determining, by the one or more processors, the predicted response based on the comparing. Still further in this variation, generating the predicted response may further include: retrieving, by the one or more processors, one or more prior responses from a response database; evaluating, by the one or more processors executing the ML chatbot, a predicted relevance of the one or more prior responses based on the user query; determining, by the one or more processors executing the ML chatbot, at least one relevant prior response from the one or more prior responses; and/or generating, by the one or more processors executing the ML chatbot, the predicted response based on the user query and the at least one relevant prior response.

In another variation of this embodiment, the set of data corresponding to the communication system may be a first set of data, and the method may further include: aggregating, by the one or more processors, a second set of data corresponding to the communication system from a plurality of internal subsystems of the communication system, wherein the second set of data includes one or more of: (i) an internal document, (ii) an archived email, (iii) a recorded verbal conversation, or (iv) a recorded live chat; and/or re-training, by the one or more processors executing the training module, the ML chatbot with the second set of data.

In yet another variation of this embodiment, the communication channel may be at least one of: (i) a live webchat, (ii) a phone call, (iii) an email, or (iv) a text message; and/or the set of data corresponding to the communication system may include one or more of: (i) a text string, (ii) an audio stream, (iii) a video stream, (iv) a file, and/or (v) a document.

In still another variation of this embodiment, the one or more live communication channels may include an audio communication channel, and the method may further include: receiving, at the one or more processors, a verbal communication across the audio communication channel; converting, by the one or more processors, the verbal communication to a first text string; determining, by the one or more processors executing the ML chatbot, a first predicted response to the verbal communication based on the first text string; generating, by the one or more processors executing the ML chatbot, the first predicted response to the verbal communication as a second text string; converting, by the one or more processors, the second text string to a second verbal communication; and/or causing, by the one or more processors, the second verbal communication to be conveyed across the audio communication channel.

Another exemplary embodiment of the present disclosure may be a system for creating an interactive knowledge base in a communication system. The system may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the system may include: one or more processors; and a non-transitory computer-readable memory coupled to the one or more processors and the user interface, the memory storing instructions thereon that, when executed by the one or more processors, cause the one or more processors to: (1) connect a training module configured to train a machine learning (ML) chatbot to a communication channel associated with the communication system, wherein the communication channel transmits data corresponding to the communication system, (2) aggregate, by executing the training module, a set of data corresponding to the communication system from a plurality of communications utilizing the communication channel, (3) train, by executing the training module, the ML chatbot with the set of data corresponding to the communication system as inputs to generate a plurality of training responses as outputs, wherein the plurality of training responses represent responses to hypothetical prompts related to the data corresponding to the communication system, and/or (4) connect the ML chatbot to one or more live communication channels of the communication system to generate predicted responses to live prompts received across the one or more live communication channels. The system may be configured to include additional, less, or alternate functionality, including that discussed elsewhere herein.

For instance, in a variation of this embodiment, the instructions, when executed, may further cause the one or more processors to: connect a user to a live agent across a first communication channel to which the ML chatbot is connected; receive a user query from the user; and/or generate, by executing the ML chatbot, a predicted response to the user query, wherein the predicted response includes a citation to a first piece of data from the set of data. Further in this variation, the instructions, when executed, may further cause the one or more processors to generate the predicted response by: generating one or more embeddings associated with the user query; comparing the one or more embeddings to a library of embeddings; and/or determining the predicted response based on the comparing. Still further in this variation, the instructions, when executed, may further cause the one or more processors to generate the predicted response by: retrieving one or more prior responses from a response database; evaluating, by executing the ML chatbot, a predicted relevance of the one or more prior responses based on the user query; determining, by executing the ML chatbot, at least one relevant prior response from the one or more prior responses; and/or generating, by executing the ML chatbot, the predicted response based on the user query and the at least one relevant prior response.

In another variation of this embodiment, the set of data corresponding to the communication system may be a first set of data, and the instructions, when executed, may further cause the one or more processors to: aggregate a second set of data corresponding to the communication system from a plurality of internal subsystems of the communication system, wherein the second set of data includes one or more of: (i) an internal document, (ii) an archived email, (iii) a recorded verbal conversation, or (iv) a recorded live chat; and/or re-train, by executing the training module, the ML chatbot with the second set of data.

In yet another variation of this embodiment, the communication channel may be at least one of: (i) a live webchat, (ii) a phone call, (iii) an email, or (iv) a text message; and/or the set of data corresponding to the communication system may include one or more of: (i) a text string, (ii) an audio stream, (iii) a video stream, (iv) a file, and/or (v) a document.

In still another variation of this embodiment, the one or more live communication channels may include an audio communication channel, and the instructions, when executed, may further cause the one or more processors to: receive a verbal communication across the audio communication channel; convert the verbal communication to a first text string; determine, by executing the ML chatbot, a first predicted response to the verbal communication based on the first text string; generate, by executing the ML chatbot, the first predicted response to the verbal communication as a second text string; convert the second text string to a second verbal communication; and/or cause the second verbal communication to be conveyed across the audio communication channel.

Yet another exemplary embodiment of the present disclosure may be a tangible machine-readable medium comprising instructions for creating an interactive knowledge base in a communication system that, when executed, may cause a machine to at least: (1) connect a training module configured to train a machine learning (ML) chatbot to a communication channel associated with the communication system, wherein the communication channel transmits data corresponding to the communication system; (2) aggregate, by executing the training module, a set of data corresponding to the communication system from a plurality of communications utilizing the communication channel; (3) train, by executing the training module, the ML chatbot with the set of data corresponding to the communication system as inputs to generate a plurality of training responses as outputs, wherein the plurality of training responses represent responses to hypothetical prompts related to the data corresponding to the communication system; and/or (4) connect the ML chatbot to one or more live communication channels of the communication system to generate predicted responses to live prompts received across the one or more live communication channels. The instructions may direct additional, less, or alternate functionality, including that discussed elsewhere herein.

For instance, in a variation of this embodiment, the instructions, when executed, may further cause the machine to at least: connect a user to a live agent across a first communication channel to which the ML chatbot is connected; receive a user query from the user; and/or generate, by executing the ML chatbot, a predicted response to the user query, wherein the predicted response includes a citation to a first piece of data from the set of data. Further in this variation, the instructions, when executed, may further cause the machine to at least generate the predicted response by: generating one or more embeddings associated with the user query; comparing the one or more embeddings to a library of embeddings; and/or determining the predicted response based on the comparing. Still further in this variation, the instructions, when executed, may further cause the machine to at least generate the predicted response by: retrieving one or more prior responses from a response database; evaluating, by executing the ML chatbot, a predicted relevance of the one or more prior responses based on the user query; determining, by executing the ML chatbot, at least one relevant prior response from the one or more prior responses; and/or generating, by executing the ML chatbot, the predicted response based on the user query and the at least one relevant prior response.

In another variation of this embodiment, the set of data corresponding to the communication system may be a first set of data, and the instructions, when executed, may further cause the machine to at least: aggregate a second set of data corresponding to the communication system from a plurality of internal subsystems of the communication system, wherein the second set of data includes one or more of: (i) an internal document, (ii) an archived email, (iii) a recorded verbal conversation, or (iv) a recorded live chat; and/or re-train, by executing the training module, the ML chatbot with the second set of data.

In yet another variation of this embodiment, the communication channel may be at least one of: (i) a live webchat, (ii) a phone call, (iii) an email, and/or (iv) a text message; and/or the set of data corresponding to the communication system may include one or more of: (i) a text string, (ii) an audio stream, (iii) a video stream, (iv) a file, and/or (v) a document.

Still another exemplary embodiment of the present disclosure may be a system for creating an interactive knowledge base in a communication system. The system may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the system may include: one or more processors; and a non-transitory computer-readable memory coupled to the one or more processors and the user interface, the memory storing instructions thereon that, when executed by the one or more processors, cause the one or more processors to: (1) connect a training module configured to train an artificial intelligence (AI) chatbot to a communication channel associated with the communication system, wherein the communication channel transmits data corresponding to the communication system, (2) aggregate, by executing the training module, a set of data corresponding to the communication system from a plurality of communications utilizing the communication channel, (3) train, by executing the training module, the AI chatbot with the set of data corresponding to the communication system as inputs to generate a plurality of training responses as outputs, wherein the plurality of training responses represent responses to hypothetical prompts related to the data corresponding to the communication system, and/or (4) connect the AI chatbot to one or more live communication channels of the communication system to generate predicted responses to live prompts received across the one or more live communication channels. The system may be configured to include additional, less, or alternate functionality, including that discussed elsewhere herein.

Yet another exemplary embodiment of the present disclosure may be a tangible machine-readable medium comprising instructions for creating an interactive knowledge base in a communication system that, when executed, may cause a machine to at least: (1) connect a training module configured to train an artificial intelligence (AI) chatbot to a communication channel associated with the communication system, wherein the communication channel transmits data corresponding to the communication system; (2) aggregate, by executing the training module, a set of data corresponding to the communication system from a plurality of communications utilizing the communication channel; (3) train, by executing the training module, the AI chatbot with the set of data corresponding to the communication system as inputs to generate a plurality of training responses as outputs, wherein the plurality of training responses represent responses to hypothetical prompts related to the data corresponding to the communication system; and/or (4) connect the AI chatbot to one or more live communication channels of the communication system to generate predicted responses to live prompts received across the one or more live communication channels. The instructions may direct additional, less, or alternate functionality, including that discussed elsewhere herein.

In accordance with the above, and with the disclosure herein, the present disclosure includes improvements in computer functionality or in improvements to other technologies at least because the disclosure describes that, e.g., a hosting server (e.g., central server), or otherwise computing device (e.g., a user computing device), is improved where the intelligence or predictive ability of the hosting server or computing device is enhanced by a trained machine learning chatbot/voice bot. This model, executing on the hosting server or user computing device, is able to accurately and efficiently determine relevant responses to user queries related to and/or otherwise associated with a communication system. That is, the present disclosure describes improvements in the functioning of the computer itself or “any other technology or technical field” because a hosting server or user computing device, is enhanced with a trained machine learning chatbot/voice bot to accurately detect, evaluate, predict, and generate query responses configured to improve a user/operator's interactive/diagnostic efforts related to a communication system and associated devices. This improves over the prior art at least because existing systems lack such evaluative and/or predictive functionality, and are generally unable to accurately analyze such query data/prompts on a real-time basis to output predictive and/or otherwise recommended responses designed to improve a user/operator's overall interactive/diagnostic efforts related to a communication system and associated devices.

As mentioned, the model(s) may be trained using machine learning and may utilize machine learning during operation. Therefore, in these instances, the techniques of the present disclosure may further include improvements in computer functionality or in improvements to other technologies at least because the disclosure describes such models being trained with a plurality of training data (e.g., 10,000s of training data corresponding to the communication system, user queries, input prompts, etc.) to output the relevant query responses configured to improve the user/operator's interactive/diagnostic efforts related to a communication system and associated devices.

Moreover, the present disclosure includes effecting a transformation or reduction of a particular article to a different state or thing, e.g., transforming or reducing the interaction processing demand and communication channel occupation times of a communication system (and associated subsystems/components/devices) from a non-optimal or error state to an optimal state by eliminating untimely/irrelevant query responses to user/operator inputs.

Still further, the present disclosure includes specific features other than what is well-understood, routine, conventional activity in the field, or adding unconventional steps that demonstrate, in various embodiments, particular useful applications, e.g., aggregating, by the one or more processors executing the training module, a set of data corresponding to the communication system from a plurality of communications utilizing the communication channel; training, by the one or more processors executing the training module, the ML chatbot with the set of data corresponding to the communication system as inputs to generate a plurality of training responses as outputs, wherein the plurality of training responses represent responses to hypothetical prompts related to the data corresponding to the communication system; and/or connecting, by the one or more processors, the ML chatbot to one or more live communication channels of the communication system to generate predicted responses to live prompts received across the one or more live communication channels.

### BRIEF DESCRIPTION OF THE DRAWINGS

The Figures described below depict various aspects of the system and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 depicts an exemplary computing system in which various embodiments of the present disclosure may be implemented.

FIG. 2A depicts a first exemplary workflow for data input/output of a computing device, for the example of FIG. 1, in accordance with various embodiments described herein.

FIG. 2B depicts a second exemplary workflow for data input/output of a computing device, for the example of FIG. 1, in accordance with various embodiments described herein.

FIG. 3 depicts an exemplary graphical user interface (GUI) that may be displayed on a computing device, in accordance with various embodiments described herein.

FIG. 4 depicts a flow diagram representing an exemplary computer-implemented method, in accordance with various embodiments described herein.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

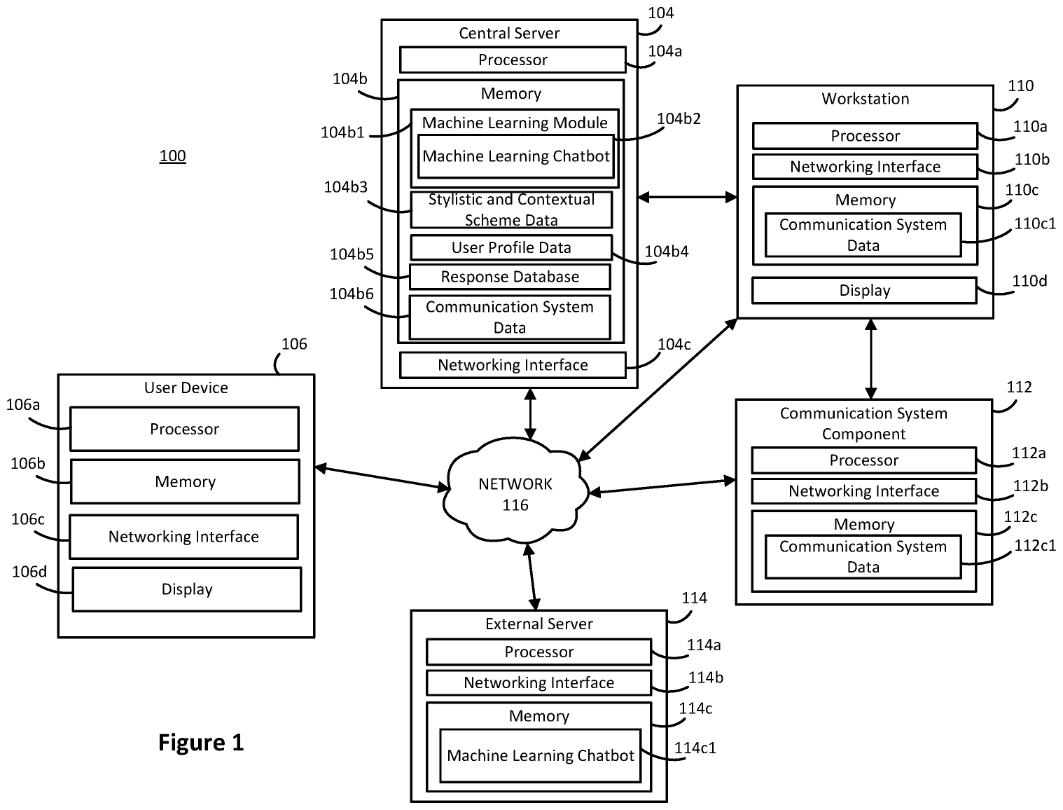

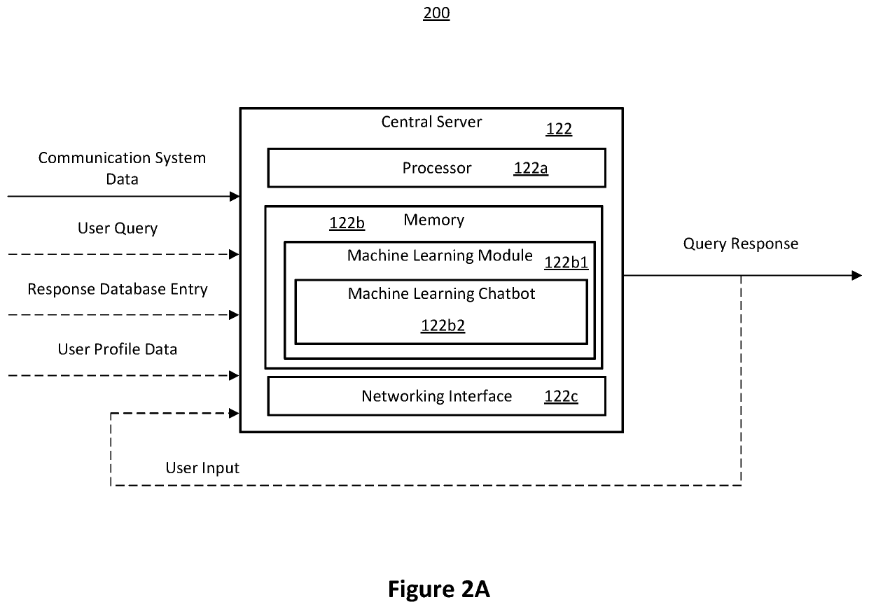

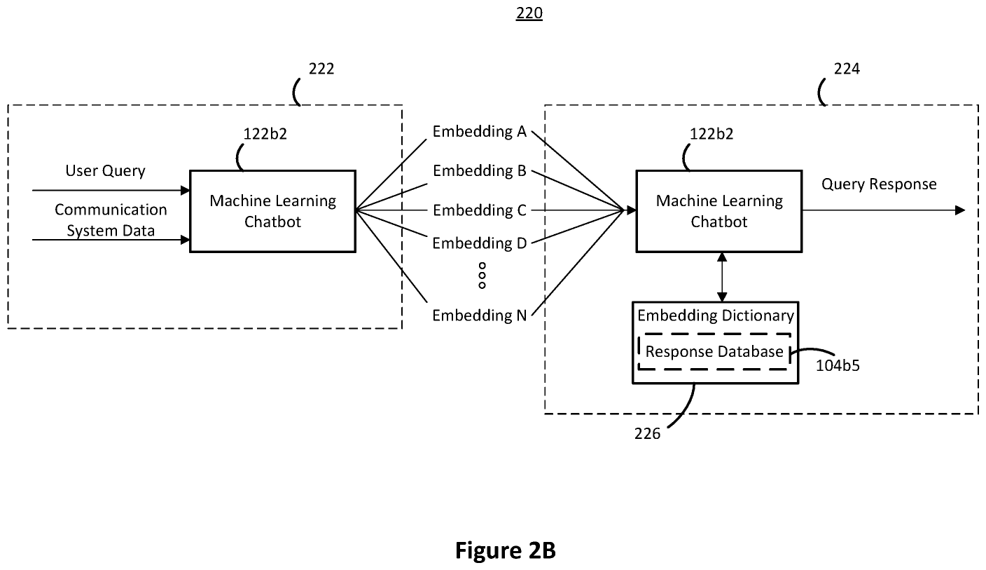

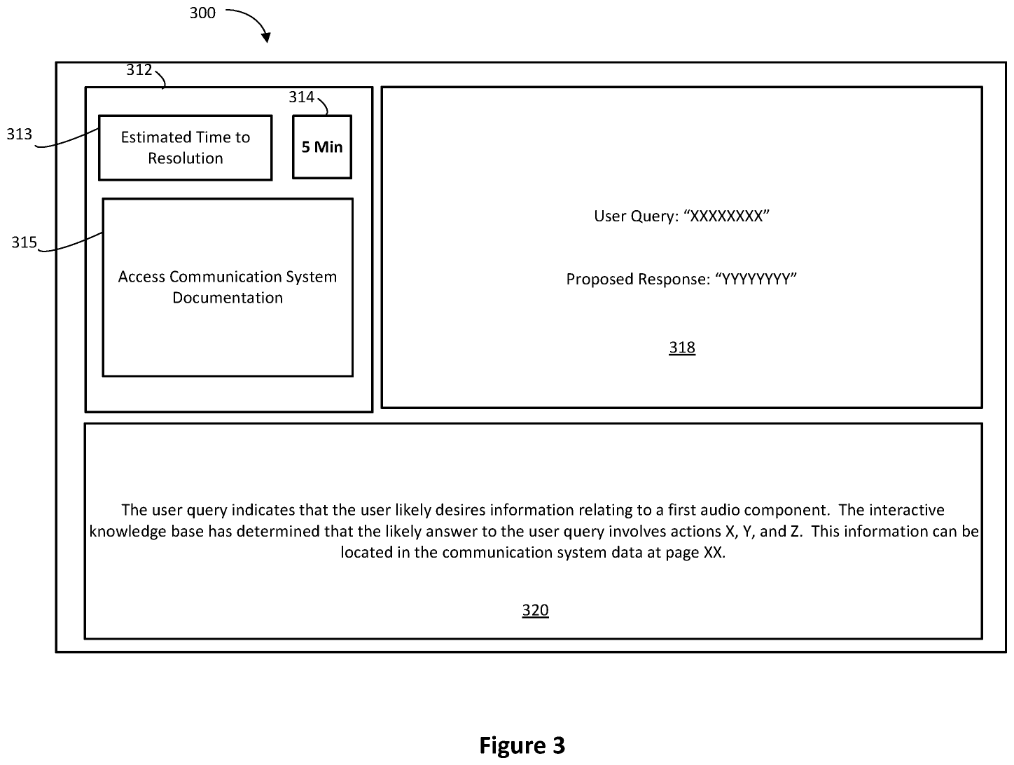

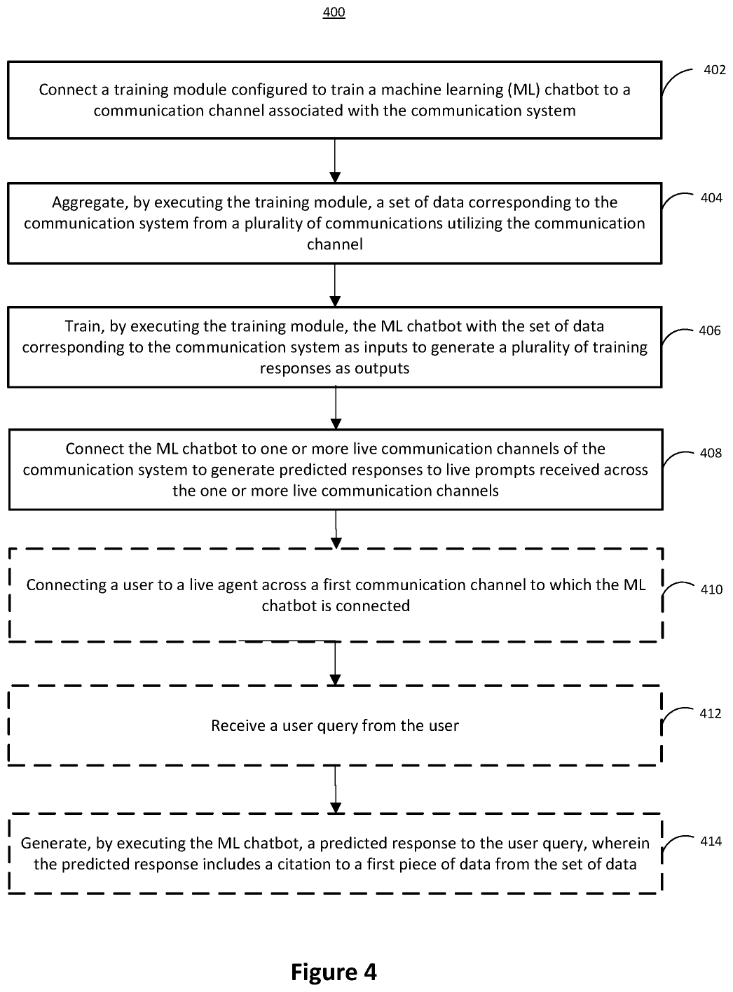

As previously mentioned, the systems and methods of the present disclosure generally relate to creating an interactive knowledge base using interactive chat machine learning models (referenced herein as a “machine learning chatbot”, “artificial intelligence chatbot”, “machine learning voice bot”, and/or “artificial intelligence voice bot”). To provide a better understanding of the systems and methods described herein, FIG. 1 depicts an exemplary computing environment in which techniques of the present disclosure may be implemented, and FIGS. 2A and 2B illustrate how some of these system components may be trained and/or otherwise configured to process user queries and/or other data to generate query responses and/or other output. FIG. 3 depicts an exemplary GUI that may feature and/or otherwise display information included as part of and/or extracted from the generated query responses and/or other output. FIG. 4 illustrates an exemplary computer-implemented method workflow for creating an interactive knowledge base and how such an interactive knowledge base may, in certain embodiments, be connected to live communication channels to receive/process user query data in real-time.

In some embodiments, generative artificial intelligence (AI) models (also referred to as generative machine learning (ML) models) including voice bots or chatbots may be configured to utilize artificial intelligence and/or machine learning techniques. Data input into the voice bots, chatbots, or other bots may include historical insurance claim data, historical home data, historical water damage data, sensor information, damage mitigation and prevention techniques, and other data. The data input into the bot or bots may include text, documents, and images, such as text, documents and images related to homes, claims, and water damage, damage mitigation and prevention, and sensors. In certain embodiments, a voice or chatbot may be a ChatGPT chatbot. The voice or chatbot may employ supervised or unsupervised machine learning techniques, which may be followed by, and/or used in conjunction with, reinforced or reinforcement learning techniques. In one aspect, the voice or chatbot may employ the techniques utilized for ChatGPT. The voice bot, chatbot, ChatGPT-based bot, ChatGPT bot, and/or other such generative model may generate audible or verbal output, text or textual output, visual or graphical output, output for use with speakers and/or display screens, and/or other types of output for user and/or other computer or bot consumption.

### Exemplary Computing System

FIG. 1 depicts an exemplary computing system 100 in which various embodiments of the present disclosure may be implemented. Depending on the embodiment, the exemplary computing system 100 may generate an error diagnosis, an update indication, a response to a user query articulated in accordance with a stylistic/contextual scheme, responses to live prompts across a communication channel of the computing system 100, and/or any other values, responses, or combinations thereof. Of course, it should be appreciated that, while the various components of the exemplary computing system 100 (e.g., central server 104, user device 106, communication system component 112, etc.) are illustrated in FIG. 1 as single components, the exemplary computing system 100 may include multiple (e.g., dozens, hundreds, thousands) of each of the components that are simultaneously connected to the network 116 at any given time.

Generally speaking, the exemplary computing system 100 may include a central server 104, a workstation 110, a user device 106, a communication system component 112, and an external server 114. As referenced herein, a “communication system” may be or include at least the central server 104, the workstation 110, the communication system component 112, and/or any other suitable devices or combinations thereof. For example, the communication system may be or include a contact center configured to field incoming calls, web-based chats, video communications, and/or any other suitable communications or combinations thereof from users connecting to the communication system (e.g., via the user device 106). The communication system may also utilize, access, and/or otherwise interact with external devices, such as the external server 114 to retrieve data (e.g., sets of data corresponding to component updates) stored thereon and/or to process data from the communication system, as described herein.

In any event, the central server 104 may generally receive data corresponding to a user device 106 connected to the communication system through a live communication channel (e.g., a live webchat, a phone call, an email, a text message, etc.) and/or one or more communication system components (e.g., from component 112), and may process the data in accordance with one or more sets of instructions contained in the memory 104b to output any of the values/responses previously described. For example, the data the central server 104 receives may be or include a text string, an audio stream, a video stream, a file, a document, and/or any other suitable data/datatype or combinations thereof.

The central server 104 may include one or more processors 104a, the memory 104b, and a networking interface 104c. The memory 104b may include various sets of executable instructions that are configured to analyze data received at the central server 104 and analyze that data to output various values. These executable instructions include, for example, a machine learning module 104b1 (also referenced herein as a “training module”) and a machine learning chatbot 104b2. The memory 104b may also store additional data and/or databases, such as a stylistic and contextual scheme data 104b3, user profile data 104b4, a response database 104b5, and communication system data 104b6.

The machine learning chatbot 104b2 may generally be an artificial intelligence (AI) trained conversational algorithm/model that is configured to interact with a user that is accessing the communication system. As a general example, when a user calls and/or otherwise accesses the central server 104 (e.g., via web-based chat, social media, text messaging, etc.), the user's verbal inputs/responses may be analyzed by the machine learning chatbot 104b2 to generate outputs, such as textual transcriptions, intent interpretations, stylistic/contextual interpretations, and/or predicted responses to such transcriptions/interpretations. In particular, the machine learning chatbot 104b2 may utilize the initial outputs (e.g., textual transcriptions, intent interpretations, and/or stylistic/contextual interpretations) to generate subsequent responses (e.g., error diagnoses, update indications, responses to user queries, etc.) that are transmitted and displayed/conveyed to the user through the user device 106. In certain embodiments, the central server 104 may create an interactive knowledge base by training/re-training the machine learning chatbot 104b2 to function as the interactive knowledge base during live communications across communications channels (e.g., a live webchat, a phone call, an email, a text message, a video call, etc.)

As a more specific example, a user may call in to the communication system, and the user may proceed to verbally communicate their requests to the communication system. In this example, the user device 106 may be and/or include the user's cellphone, telephone, microphone connected to a computing device, and/or any other suitable device(s) or combinations thereof. These verbal inputs may be routed through the network 116 to the central server 104, where the machine learning chatbot 104b2 may analyze the verbal inputs to generate initial outputs (e.g., textual transcriptions, intent interpretations, stylistic/contextual interpretations, etc.). The machine learning chatbot 104b2 may then analyze these initial outputs to determine a predicted response that may address the user's request(s). The machine learning chatbot 104b2 may repeatedly/iteratively perform this response generation until the user terminates the communication stream (e.g., hangs up the phone, disconnects from the website, etc.) and/or until the user receives and confirms satisfactory responses to their requests, when the central server 104 may automatically terminate the communication stream.

Further in this example, the central server 104 may receive a user query from a user (e.g., via user device 106) requesting information from the communication system. The central server 104 may execute the machine learning chatbot 104b2 to determine a stylistic scheme and/or a contextual scheme (e.g., using the stylistic and contextual scheme data 104b3) for a response to the user query, and the server 104 may further utilize the machine learning chatbot 104b2 to generate a response to the user query that is articulated in accordance with the stylistic scheme and/or the contextual scheme. The stylistic scheme may represent how a user generally conveys information (e.g., informally, high numbers of colloquialisms, short/long sentences), and as such, the stylistic scheme may inform how the machine learning chatbot 104b2 formats answers in a manner that closely mimics the user's preferred communication style. Similarly, the contextual scheme may represent the subject matter of the conversation (e.g., personal injuries, vehicle accidents) and the gravitas (or lack thereof) typically associated therewith, and/or may represent a predicted tone (e.g., happy, sad, angry, etc.) a user is using when chatting with the machine learning chatbot 104b2. Regardless, the central server 104 may then transmit and/or otherwise cause the response to be displayed/conveyed for a user/operator by the workstation 110 and/or the user device 106 for interpretation by the user/operator.

Continuing the above example, the central server 104 may receive the user queries from the user device 106, proceed to analyze the user queries and generate initial outputs (e.g., textual transcriptions, intent interpretations, stylistic/contextual interpretations, etc.), and generate a response in accordance with a particular stylistic and/or contextual scheme. The central server 104, and more particularly, the machine learning chatbot 104b2, may evaluate the stylistic and contextual scheme data 104b3 in tandem with the initial outputs to determine a stylistic scheme and/or a contextual scheme for a response to the user query. Based upon the in tandem analysis, the machine learning chatbot 104b2 may generate a response that is articulated in accordance with the stylistic scheme and/or the contextual scheme.

The stylistic and contextual scheme data 104b3 may generally include information/data that relates particular words/character strings to articulation styles and/or contextual inferences. For example, a character string comprising a user query may be: “This is excellent!”. This user query may indicate both that the user is happy (e.g., due to the word “excellent” and the subsequent “!”), and that the user prefers to communicate in shorter sentences (e.g., due to the three-word sentence). Thus, the central server 104 may determine a stylistic scheme to format/articulate a short response to mimic the user's conversation style, as well as a contextual scheme to format/articulate the response in a light, cheerful tone that mimics the user's conversational tone and may likely maintain the user's happy mood (e.g., “You're welcome, have a good day!”).

As another example, a character string comprising a user query may be: “I was involved in an automobile accident several days ago, and I need to file an insurance claim”. This user query may indicate that the conversation concerns a serious topic (e.g., due to words such as “automobile accident” and “insurance claim”), and that the user is in a business-like, stoic mood (e.g., due to straightforward phrasing of the user query). Thus, the central server 104 may determine a contextual scheme to format/articulate a response in a business-like, stoic tone (e.g., “I am very sorry to hear about your automobile accident. I will need some information from you to begin the claim process”) to indicate an understanding of the conversational context and to mimic the user's conversational tone. In this manner, the machine learning chatbot 104b2 may likely avoid insulting/offending/upsetting the user by providing a relevant response that appears to appreciate the contextual significance of the user's query.

In some embodiments, the central server 104 may include user profile data 104b4 that may include multiple user profiles that each indicate respective communication preferences (e.g., communication channels, stylistic preferences, etc.) for users. The central server 104 may receive an initial communication from the user device 106 when establishing a communication stream across a communication channel, and this initial communication may include data corresponding to a particular user profile. The central server 104 may then access/retrieve the corresponding data from the user profile data 104b4 to establish and communicate with a user according to their preferences. Moreover, the central server 104 may automatically instruct the machine learning chatbot 104b2 to generate responses in accordance with the user profile data 104b4 during the live communication with the user across the communication channel.

For example, data stored as part of the user profile data 104b4 corresponding to a first user may indicate that the first user prefers to talk over a telephone communication channel, and prefers a stoic conversational tone. In this example, the central server 104 may receive an initial communication across a web-based chat communication channel from a user device 106 corresponding to the first user, and the central server 104 may execute the machine learning chatbot 104b2 to generate an initial communication to the user asking whether the first user would prefer to discuss their inquiries via a phone call. As the conversation progresses, the central server 104 may execute the machine learning chatbot 104b2 in a manner that generates stoic responses to the first user's inquiries, per the user profile data 104b4 associated with the first user. However, if the tone or context of the conversation changes, the central server 104 may execute the machine learning chatbot 104b2 to generate responses that account for such changes. Thus, the central server 104 may utilize the user profile data 104b4 to generate responses/communications for the first user (e.g., via the machine learning chatbot 104b2) that correspond to the first user's preferences, and that may intelligently evolve/change to match the tone/style/context of the conversation.

Additionally, or alternatively, the user profile data 104b4 may indicate which services (e.g., textual transcription, intent interpretation, stylistic/contextual interpretation, etc.) that are performed by the machine learning chatbot 104b2 a particular user prefers to have applied to their inquiries transmitted across a communication channel to the central server 104. For example, the user profile for a second user may indicate that the second user prefers to discuss inquiries with a live agent, and does not want any services from the machine learning chatbot 104b2. Of course, any user may have or include any suitable number of preferences as part of the user profile data 104b4, and the user profile data 104b4 may include any suitable number of services provided by the machine learning chatbot 104b2.

In certain embodiments, the central server 104 may include a response database 104b5 that stores prior/historical responses of the machine learning chatbot 104b2. The machine learning chatbot 104b2 may utilize the prior responses stored in the response database 104b5 to, for example, generate a response to a user query. The machine learning chatbot 104b2 may receive a user query, and in some embodiments, may extract/retrieve one or more embeddings from the user query. The machine learning chatbot 104b2 may then compare these embeddings to embeddings of prior responses in the response database 104b5 to identify prior responses that may have addressed a similar user query, and may generate a response based upon the identified prior responses and the stylistic and/or contextual scheme.

In some embodiments, the central server 104 may include communication system data 104b6 that may be used to create the interactive knowledge base by training/re-training the machine learning chatbot 104b2 with the data 112cl to function as the interactive knowledge base during live communications across communications channels. Generally speaking, the communication system data 104b6 may be or include communications, documents, files, and/or any other suitable record or combinations thereof that include information corresponding to the communication system. For example, the communication system data 104b6 may be or include an internal document, a received document, an archived email, a recorded verbal conversation, a recorded live chat, a video file, and/or a recorded text message.

The communication system data 104b6 may also correspond to communications between/among users/operators within the communication system, external users (e.g., via user device 106), and/or any other users or combinations thereof. The internal/received document may be, for example, an internal operations manual associated with the communication system component 112, that details the maintenance/servicing requirements, troubleshooting, and/or other aspects or combinations thereof of the component 112. The archived email may be or include an email transmitted between/among users/operators within the communication system that includes information associated with the communication system component 112 (and/or other subsystems/components). Similarly, the recorded verbal conversation, recorded live chat, video file, and/or the recorded text message may generally be or include corresponding communications between/among users/operators within the communication system, external users (e.g., via user device 106), and/or any other users or combinations thereof.

As an example of other possible outputs by the machine learning chatbot 104b2, the central server 104 may receive a set of data from a source external to the communication system (e.g., user device 106, external server 114), the set of data corresponding to updates to a communication system component (e.g., communication system component 112). The central server 104 may execute the machine learning chatbot 104b2 to determine that the set of data corresponds to such updates, and the server 104 may further utilize the machine learning chatbot 104b2 to generate an update indication corresponding to the set of data. For example, the update indication may include which communication system component is receiving an update, when the update is scheduled to take place, how long the update may take, and/or any other suitable information or combinations thereof. The central server 104 may then transmit and/or otherwise cause the update indication to be displayed/conveyed for a user/operator by the workstation 110 for interpretation and/or review of a generated template based upon the update indication.

As another example of other possible outputs by the machine learning chatbot 104b2, the central server 104 may connect a training module (e.g., machine learning module 104b1) to communication channel(s) of the communication system. The central server 104 may then aggregate (e.g., via the machine learning module 104b1) a set of data from a plurality of communications utilizing the communication channel(s) of the communication system. The central server 104 may then execute the machine learning module 104b1 to train the machine learning chatbot 104b2 with the set of data from the plurality of communications to generate a plurality of training responses to hypothetical prompts. The central server 104 may then connect the machine learning chatbot 104b2 to live communication channel(s) to generate predicted responses to live prompts received across the live communication channel(s). For example, the communication channel may be or include a telecommunication channel, a web-based chat channel, a video channel, and/or any other suitable communication channel or combinations thereof.

In order to execute these or other instructions stored in memory 104b, the central server 104 may communicate with a workstation 110. The workstation 110 may generally be any computing device that is communicatively coupled with the central server 104, and more particularly, may be a computing device with administrative permissions that enable a user accessing the workstation 110 to update and/or otherwise change data/models/applications that are stored in the memory 104b. For example, the workstation 110 may enable a user to access the central server 104, and the user may train the machine learning chatbot 104b2 that is stored in the memory 104b. As discussed herein, in certain embodiments, the machine learning chatbot 104b2 may be trained by and may implement machine learning techniques. In these embodiments, the user accessing the workstation 110 may upload training data, execute training sequences to train the chatbot 104b2, and may update/re-train the chatbot 104b2 over time. The workstation 110 may include one or more processors 110a, a networking interface 110b, a memory 110c, and a display 110d. The memory 110c may also include communication system data 110cl, that the workstation 110 may transmit to the central server 104 and/or utilize independently to create the interactive knowledge base by training/re-training the machine learning chatbot 104b2 with the data 110cl to function as the interactive knowledge base during live communications across communications channels.

In some embodiments, the central server 104 may store and execute instructions that may generally train the machine learning chatbot 104b2 stored in the memory 104b. For example, the central server 104 may execute instructions included as part of the machine learning module 104b1 that are configured to train the machine learning chatbot 104b2 to output an error diagnosis, an update indication, a response to a user query articulated in accordance with a stylistic/contextual scheme, to function as an interactive knowledge base by generating responses to live prompts across a communication channel of the computing system 100, and/or any other values, responses, or combinations thereof. In certain embodiments, the central server 104 may create an interactive knowledge base by training/re-training the machine learning chatbot 104b2 to function as the interactive knowledge base during live communications across communications channels (e.g., a live webchat, a phone call, an email, a text message, a video call, etc.).

In particular, the training dataset(s) may include a plurality of training error indications as inputs and/or a plurality of training error diagnoses, a plurality of training data corresponding to the communication system and/or a plurality of training update indications, a plurality of training user queries and/or a plurality of training responses, a plurality of training sets of data corresponding to the communication system and/or a plurality of training responses, and/or any other suitable data and combinations thereof. However, in certain embodiments, the machine learning chatbot 104b2 may be a rules-based algorithm configured to receive error indications, data corresponding to the communication system, and/or user queries as input and to output error diagnoses, update indications, and/or responses as output.

In some embodiments, the machine learning chatbot 104b2 may be configured to utilize artificial intelligence and/or machine learning techniques. For instance, the machine learning chatbot 104b2 may be a ChatGPT chat bot. The machine learning chatbot 104b2 may employ supervised or unsupervised machine learning techniques, which may be followed or used in conjunction with reinforced or reinforcement learning techniques. The machine learning chatbot 104b2 may employ the techniques utilized for ChatGPT. The machine learning chatbot 104b2 (or other voice bot, chatbot, ChatGPT-based bot, ChatGPT bot, and/or other bots employed by the techniques, systems, and embodiments discussed herein), may generate audible or verbal output, text or textual output, visual or graphical output, output for use with speakers and/or display screens, and/or other types of output for user and/or other computer or bot consumption.

Noted above, in some embodiments, the machine learning chatbot 104b2 or other computing device may be configured to implement machine learning, such that the central server 104 “learns” to analyze, organize, and/or process data without being explicitly programmed. Machine learning may be implemented through machine learning methods and algorithms. In one exemplary embodiment, a machine learning module may be configured to implement machine learning methods and algorithms.

In some embodiments, at least one of a plurality of machine learning methods and algorithms may be applied, which may include but are not limited to: linear or logistic regression, instance-based algorithms, regularization algorithms, decision trees, Bayesian networks, naïve Bayes algorithms, cluster analysis, association rule learning, neural networks (e.g., convolutional neural networks, deep learning neural networks, combined learning module or program), deep learning, combined learning, reinforced learning, dimensionality reduction, support vector machines, k-nearest neighbor algorithms, random forest algorithms, gradient boosting algorithms, Bayesian program learning, voice recognition and synthesis algorithms, image or object recognition, optical character recognition, natural language understanding, and/or other ML programs/algorithms either individually or in combination. In various embodiments, the implemented machine learning methods and algorithms are directed toward at least one of a plurality of categorizations of machine learning, such as supervised learning, unsupervised learning, and reinforcement learning.

In one embodiment, the machine learning chatbot 104b2 employs supervised learning, which involves identifying patterns in existing data to make predictions about subsequently received data. Specifically, the machine learning chatbot 104b2 may be “trained” using training data, which includes example inputs and associated example outputs. Based upon the training data, the machine learning chatbot 104b2 may generate a predictive function which maps outputs to inputs and may utilize the predictive function to generate machine learning outputs based upon data inputs. The exemplary inputs and exemplary outputs of the training data may include any of the data inputs or machine learning outputs described above. In the exemplary embodiment, a processing element may be trained by providing it with a large sample of data with known characteristics or features.

In another embodiment, the machine learning chatbot 104b2 may employ unsupervised learning, which involves finding meaningful relationships in unorganized data. Unlike supervised learning, unsupervised learning does not involve user-initiated training based upon example inputs with associated outputs. Rather, in unsupervised learning, the machine learning chatbot 104b2 may organize unlabeled data according to a relationship determined by at least one machine learning method/algorithm employed by the machine learning chatbot 104b2. Unorganized data may include any combination of data inputs and/or machine learning outputs as described above.

In yet another embodiment, a machine learning chatbot 104b2 may employ reinforcement learning, which involves optimizing outputs based upon feedback from a reward signal. Specifically, the machine learning chatbot 104b2 may receive a user-defined reward signal definition, receive a data input, utilize a decision-making model to generate a machine learning output based upon the data input, receive a reward signal based upon the reward signal definition and the machine learning output, and alter the decision-making model so as to receive a stronger reward signal for subsequently generated machine learning outputs. Other types of machine learning may also be employed, including deep or combined learning techniques.

As an example, the machine learning chatbot 104b2 may employ natural language processing (NLP) functions, which generally involves understanding verbal/written communications and generating responses to such communications. The machine learning chatbot 104b2 may be trained to perform such NLP functionality using a symbolic method, machine learning models, and/or any other suitable training method. As an example, the machine learning chatbot 104b2 may be trained to perform at least two techniques that may enable the machine learning chatbot 104b2 to understand words spoken/written by a user: syntactic analysis and semantic analysis.

Syntactic analysis generally involves analyzing text using basic grammar rules to identify overall sentence structure, how specific words within sentences are organized, and how the words within sentences are related to one another. Syntactic analysis may include one or more sub-tasks, such as tokenization, part of speech (POS) tagging, parsing, lemmatization and stemming, stop-word removal, and/or any other suitable sub-task or combinations thereof. For example, using syntactic analysis, the machine learning chatbot 104b2 may generate textual transcriptions from verbal responses from a user in a data stream.

Semantic analysis generally involves analyzing text in order to understand and/or otherwise capture the meaning of the text. In particular, the machine learning chatbot 104b2 applying semantic analysis may study the meaning of each individual word contained in a textual transcription in a process known as lexical semantics. Using these individual meanings, the machine learning chatbot 104b2 may then examine various combinations of words included in the sentences of the textual transcription to determine one or more contextual meanings of the words. Semantic analysis may include one or more sub-tasks, such as word sense disambiguation, relationship extraction, sentiment analysis, and/or any other suitable sub-tasks or combinations thereof. For example, using semantic analysis, the machine learning chatbot 104b2 may generate one or more intent interpretations based upon one or more textual transcriptions from a syntactic analysis.

After training, machine learning programs (or information generated by such machine learning programs) may be used to evaluate additional data. Such data may be and/or may be related to communication system component data, communication channel data, user device data, and/or other data that was not included in the training dataset. The trained machine learning programs (or programs utilizing models, parameters, or other data produced through the training process) may accordingly be used for determining, assessing, analyzing, predicting, estimating, evaluating, or otherwise processing new data not included in the training dataset. Such trained machine learning programs may, therefore, be used to perform part or all of the analytical functions of the methods described elsewhere herein.

It is to be understood that supervised machine learning and/or unsupervised machine learning may also comprise retraining, relearning, or otherwise updating models with new, or different, information, which may include information received, ingested, generated, or otherwise used over time. Further, it should be appreciated that, as previously mentioned, the machine learning chatbot 104b2 may be used to output an error diagnosis, an update indication, a response to a user query articulated in accordance with a stylistic/contextual scheme, responses to live prompts across a communication channel of the computing system 100, and/or any other values, responses, or combinations thereof using artificial intelligence (e.g., a machine learning model of the machine learning chatbot 104b2) or, in alternative aspects, without using artificial intelligence.

Moreover, although the methods described elsewhere herein may not directly mention machine learning techniques, such methods may be read to include such machine learning for any determination or processing of data that may be accomplished using such techniques. In some aspects, such machine learning techniques may be implemented automatically upon occurrence of certain events or upon certain conditions being met. In any event, use of machine learning techniques, as described herein, may begin with training a machine learning program, or such techniques may begin with a previously trained machine learning program.

In any event, the central server 104 may execute the machine learning chatbot 104b2 to generate a response to a user query, and the server 104 may then transmit the response to the workstation 110 for display to a user/operator. The user/operator may then review the proposed response from the machine learning chatbot 104b2 in circumstances where the chatbot 104b2 is not configured to communicate autonomously with a user device 106 and/or when the user/operator specifically prompts the machine learning chatbot 104b2 for a predicted/proposed response as part of a live communication/conversation the user/operator is having with the user of the user device 106. Moreover, in certain embodiments, the central server 104 may also initiate communication between the workstation 110 and the user device 106, from which, the user query originated. In this manner, the user/operator may seamlessly begin communicating with the user via the user device 106, and may optionally utilize the proposed/predicted response generated by the machine learning chatbot 104b2 in response to the user's query.

Generally, the user device 106 may be or include any device that is associated with (e.g., configured to connect with, etc.) a particular user, who may connect to, post about, and/or otherwise provide data that may be transmitted to the communication system through the network 116. In certain embodiments, the user device 106 may be a personal computing device of that user, such as a smartphone, a tablet, smart glasses, or any other suitable device or combination of devices (e.g., a smart watch plus a smartphone) with wireless communication capability. In the embodiment of FIG. 1, the user device 106 may include a processor 106a, a memory 106b, a networking interface 106c, and a display 106d.

The user device 106 may be communicatively coupled to the central server 104, the workstation 110, the communication system component 112, and/or the external server 114. For example, the user device 106 and the central server 104, the workstation 110, the communication system component 112, and/or the external server 114 may communicate via USB, Bluetooth, Wi-Fi Direct, Near Field Communication (NFC), etc. For example, the central server 104 may transmit an error diagnosis, a response to a user query articulated in accordance with a stylistic/contextual scheme, responses to live prompts across a communication channel of the computing system 100, and/or any other values, responses, or combinations thereof to the user device 106 via the networking interface 104c, which the user device 106 may receive via the networking interface 106c.

The communication system component 112 may generally be or include any suitable type of component that may facilitate and/or otherwise be configured to perform functions that enable the processing/transmission of communications across various communication channels. For example, a communication system component 112 may be a switch, a router, a telephone service, a cloud-based service, a software package, a website, and/or any other suitable components of a communication system. Further, the communication system component 112 may be communicatively coupled to the network 116, as well as directly connected (e.g., via an internal network) to the workstation 110 and/or the central server 104. The communication system component 112 may include a processor 112a, a networking interface 112b, and a memory 112c. The memory 112c may also include communication system data 112cl associated with the component 112 and/or other subsystems/components that the communication system component 112 may transmit to the workstation 110 and/or the central server 104 to create the interactive knowledge base by training/re-training the machine learning chatbot 104b2 with the data 112cl to function as the interactive knowledge base during live communications across communications channels.

The external server 114 may be or include computing servers and/or combinations of multiple servers storing data that may be accessed/retrieved by the central server 104, the user device 106, the workstation 110, and/or the communication system component 112. The data stored by the external server 114 may include a machine learning chatbot 114cl that is configured to generate similar outputs to the machine learning chatbot 104b2. In certain embodiments, the external server 114 may receive data from the central server 104, the user device 106, the workstation 110, and/or the communication system component 112, and may execute the machine learning chatbot 114cl to generate the outputs described herein. The external server 114 may include a processor 114a, a networking interface 114b, and a memory 114c that includes the machine learning chatbot 114c1.

Each of the processors 104a, 106a, 110a, 112a, 114a may include any suitable number of processors and/or processor types. For example, the processors 104a, 106a, 110a, 112a, 114a may include one or more CPUs and one or more graphics processing units (GPUs). Generally, each of the processors 104a, 106a, 110a, 112a, 114a may be configured to execute software instructions stored in each of the corresponding memories 104b, 106b, 110c, 112c, 114c. The memories 104b, 106b, 110c, 112c, 114c may include one or more persistent memories (e.g., a hard drive and/or solid state memory) and may store one or more applications, modules, and/or models, such as the machine learning module 104b1 and/or the machine learning chatbot 104b2.

The networking interface 104c may enable the central server 104 to communicate with the workstation 110, the user device 106, the communication system component 112, the external server 114, and/or any other suitable devices or combinations thereof. More specifically, the networking interface 104c enables the central server 104 to communicate with each component of the exemplary computing system 100 across the network 116 through their respective networking interfaces 106c, 110b, 112b, 114b. The networking interface 104c may support wired or wireless communications, such as USB, Bluetooth, Wi-Fi Direct, Near Field Communication (NFC), etc. The networking interface 104c may enable the central server 104 to communicate with the various components of the exemplary computing system 100 via a wireless communication network such as a fifth-, fourth-, or third-generation cellular network (5G, 4G, or 3G, respectively), a Wi-Fi network (802.11 standards), a WiMAX network, a wide area network (WAN), a local area network (LAN), etc.

Moreover, the network 116 may be a single communication network, or may include multiple communication networks of one or more types (e.g., one or more wired and/or wireless personal or local area networks (PANs or LANs), and/or one or more wide area networks (WANs) such as the Internet). In some embodiments, the network 116 includes multiple, entirely distinct networks (e.g., one or more networks for communications between central server 104 and user device 106, and a separate, Bluetooth or wireless LAN (WLAN) network for communications between central server 104 and workstation 110, and so on).

It will be understood that the above disclosure is one example and does not necessarily describe every possible embodiment. As such, it will be further understood that alternate embodiments may include fewer, alternate, and/or additional steps or elements.

### Exemplary Workflows for a Computing Device

FIG. 2A, depicts a first exemplary workflow 200 for data input/output of a computing device (e.g., the central server 104) of FIG. 1, in accordance with various embodiments described herein. The first exemplary workflow 200 generally illustrates various data received/retrieved by the central server 122 that is utilized by the machine learning chatbot 122b2 as inputs to generate various outputs. The various data received/retrieved by the central server 122 includes communication system data, user queries, response database entries, user profile data, and/or user inputs. The outputs generated by the machine learning chatbot 122b2 based upon the received/retrieved data includes a query response. As illustrated in FIG. 2A, the central server 122 includes a processor 122a, a memory 122b, a machine learning module 122b1, a machine learning chatbot 122b2, and a networking interface 122c.

As previously described, the communication system data, user queries, response database entries, user profile data, and/or user inputs received/retrieved by the central server 122 may include a large variety of specific information/data. For example, the communication system data may be or include communications, documents, files, and/or any other suitable record or combinations thereof that include information corresponding to the communication system. For example, the communication system data 104b6 may be or include a text string, an internal document, a received document, an archived email, a recorded file, a live audio stream, recorded verbal conversation, a recorded live chat, a live video call, a recorded video file, and/or a recorded text message. Using the communication system data and/or other suitable data, the central server 122 may create the interactive knowledge base by training/re-training the machine learning chatbot 104b2 with the communication system data to function as the interactive knowledge base during live communications across various communications channels, such as a live webchat, a phone call, an email, a text message, and/or a video call.

For example, the communication system data may include question and answer (Q&A) documents related to customer service questions/complaints, frequently asked questions (FAQ) documents, internal communications between workstations (e.g., workstation 110) describing answers to particular issues related to the communication system, a plurality of documentation corresponding to conversation topics (e.g., underlying services utilizing the communication system) of the communication system, communication system subsystem/component errors and/or solutions to such errors, and/or any other suitable data or combinations thereof.

The user queries may be or include a verbal communication, a textual communication, and/or a visual communication. More specifically, the user queries may be or include textual data and/or other character strings that may indicate a user question or other prompt, verbal data indicating the user question or other prompt, image data corresponding to a user query (e.g., vehicle damage for an insurance claim), and/or any other suitable information or combinations thereof. Of course, as referenced herein, the user queries may correspond to queries submitted and/or otherwise input into the machine learning chatbot 122b2 by/from an external user (e.g., using user device 106), an internal user/operator (e.g., via workstation 110), and/or from any other user(s) using any other suitable device(s) (e.g., external server 114) to access the central server 122.

The response database entries may be or include prior/historical responses of the machine learning chatbot 122b2. For example, the machine learning chatbot 122b2 may receive a user query, and in some embodiments, may extract/retrieve one or more embeddings from the user query. The machine learning chatbot 104b2 may then compare these embeddings to embeddings of the response database entries to identify prior responses that may have addressed a similar user query, and may generate the query response based, in part, on the response database entries.

The user profile data may be or include data indicating respective communication preferences (e.g., communication channels, stylistic preferences, etc.) for users, and/or any other suitable data or combinations thereof. The user input may be or include data corresponding to user/operator feedback regarding accuracy/relevance of outputs from the machine learning chatbot 122b2, and/or any other suitable data or combinations thereof.

Of course, in certain instances, the central server 122 may not receive any user query, response database entries, user profile data, and/or user input. In these instances, the central server 122 may receive only the communication system data, and may proceed to train/re-train the machine learning chatbot 122b2 to operate as an interactive knowledge base associated with a communication system. Thus, in certain embodiments, the query response may be a training response representing a response to a hypothetical prompt related to the communication system data. The central server 122 may receive the communication system data, and may generate a hypothetical (training) prompt based on the communication system data using instructions stored in the machine learning module 122b1.

For example, the communication system data may include information corresponding to maintenance information for a first communication system component (e.g., communication system component 112). The central server 122 may execute instructions included as part of the machine earning module 122b1 to generate a hypothetical prompt based on this maintenance information, such as a query requesting information (contained in the communication system data) on how to resolve a maintenance issue with the first communication system component. The machine learning chatbot 122b2 may generate a training response to the hypothetical prompt, and a user/operator may review the information included in the training response to determine whether the chatbot 122b2 accurately referenced the information in the communication system data to provide the requested maintenance information for the first communication system component.

Based on the information contained in the training response, the user may provide user input to help train the machine learning chatbot 122b2. If the machine learning chatbot 122b2 does not reference the communication system data, then the user/operator may provide user input that may improve the machine learning chatbot's 122b2 ability or likelihood to correctly reference the communication system data when receiving a similar/identical prompt/query in future iterations. If the machine learning chatbot 122b2 correctly references the communication system data, the use may provide user input confirming and/or reinforcing the chatbot's 122b2 weightings and/or other parameters to ensure that the chatbot 122b2 provides similarly correct information when receiving a similar/identical prompt/query in future iterations.

When the central server 122 has successfully trained/re-trained the machine learning chatbot 122b2, the chatbot 122b2 may be connected to one or more live communication channels to generate predicted responses to live prompts (user queries). For example, the central server 122 may connect the trained/re-trained machine learning chatbot 122b2 to and/or otherwise transmit live data from a live communication channel, and the chatbot 122b2 may receive communication system data and user queries while connected to the live communication channel. The machine learning chatbot 122b2 may analyze the communication system data and the user query, and may generate a predicted response to the user query while connected to the live communication channel. In this manner, the machine learning chatbot 122b may provide the most accurate, up-to-date information in response to user queries during live communications with users/operators across live communication channels.

For example, the central server 122 may connect the machine learning chatbot 122b2 to a live webchat communication channel to which a live agent (e.g., via workstation 110) and an external user (e.g., via user device 106) are also connected. The external user may provide a written query requesting information associated with a first device supplied by an entity associated with the communication system. The machine learning chatbot 122b2 may receive the written query, analyze the written query and any stored/accessed/retrieved communication system data corresponding to the first device, and may generate a query response providing the information associated with the first device requested by the external user. Thus, if the live agent is unable to recall, locate, and/or otherwise quickly provide the information associated with the first device, the live agent may reference the query response generated by the machine learning chatbot 122b2 to communicate the requested information to the external user.

Additionally, or alternatively, the machine learning chatbot 122b2 may check/validate information supplied by live agents and/or other users/operators during communications across one or more live communication channels. For example, the central server 122 may connect the machine learning chatbot 122b2 to a live phone call communication channel to which a live agent (e.g., via workstation 110) and an external user (e.g., via user device 106) are also connected. The machine learning chatbot 122b2 may receive the audio data stream being transmitted across the live phone call communication channel, and may frequently/constantly process the audio data to determine predicted query responses.

The live agent may, for example, provide information to the external user that contains an incorrect and/or otherwise erroneous statement associated with a particular service/product offered by the entity operating the communication system. The machine learning chatbot 122b2 may receive this audio data and may check the information contained therein against the available communication system data to determine that the live agent provided incorrect and/or otherwise erroneous information to the external user. Accordingly, the machine learning chatbot 122b2 may generate a predicted response for display to the live agent and/or the external user indicating the incorrect/erroneous information and the correct information.

As another example, the machine learning chatbot 122b2 may receive a user query across a live communication channel indicating a user's question associated with a communication system component (e.g., communication system component 112), and the communication system data may be or include a maintenance document that includes specification information related to the communication system component. The machine learning chatbot 122b2 may interpret the user query to determine that the user's question is associated with the communication system component, and the chatbot 122b2 may subsequently interpret the communication system data to determine relevant information corresponding to the communication system component and the user's question. The chatbot 122b2 may, for example, attempt to locate keywords from the user query in the communication system data to provide a query response that has explicit support within the data. In circumstances, where the machine learning chatbot 122b2 is able to locate such explicit support (or less explicit support), the chatbot 122b2 may provide a citation or other reference to the communication system data as part of the query response.

To illustrate, the machine learning chatbot 122b2 may receive a user query indicating that a first communication system component (e.g., a router) is not functioning properly and that the user desires assistance in resolving a particular error. The user query may indicate the nature and/or specifics regarding the particular error, and the machine learning chatbot 122b2 may analyze the communication system data to determine information regarding errors experienced by the first communication system component. As a result of the analysis, the machine learning chatbot 122b2 may determine that the first communication system component is experiencing the particular error, and may further determine a potential solution to the particular error. Therefore, the machine learning chatbot 122b2 may output a query response indicating that the particular error may be resolved by applying the potential solution, and may provide a citation to a relevant portion of the communication system data.

In any event, as mentioned, the query response may generally include a set of information predicted to address at least a portion of the user query. However, in order to generate the query response, the central server 122 may ensure that the machine learning chatbot 122b2 is able to process the communication system data, user query, and/or other received data by converting the communication system data, user query, and/or other data into a text string or other suitable data format. For example, the central server 122 may receive communication system data in the form of a verbal (e.g., recorded/live audio stream data) and/or visual communication (e.g., recorded/live video stream data), and may convert the communication system data to a first text string. The machine learning chatbot 122b2 may then generate the query response as a second text string, and the central server 122 may convert the second text string to a second verbal communication or a second visual communication for responding to the user across a similar/identical communication medium/channel (e.g., audio, text, visual) as the original user query.

Practically speaking, the machine learning chatbot 122b2 may output the query response as a set of classification values and/or classifications that have associated confidence value(s)/interval(s). For example, the query response may include a first predicted response with a confidence value of 80%. Of course, the query response may be or include predicted query response(s) and/or predicted citation(s) to relevant communication system data indicated in any suitable manner, such as a single numerical value (e.g., 1, 2, 3, etc.), a confidence interval, a percentage (e.g., 95%, 50%, etc.), an alphanumerical character(s) (e.g., A, B, C, etc.), a symbol, and/or any other suitable value or indication of a likelihood that the query response is accurate.

In some embodiments, the machine learning chatbot 122b2 may output the query response as a set or list of classification values corresponding to the likely predicted query response(s) for a particular user query. For example, the machine learning chatbot 122b2 may output a first predicted response with a first citation to a particular set of communication system data with a confidence value of 95%, a second predicted response with a second citation to a particular set of communication system data with a confidence value of 75%, and a third predicted response with a third citation to a particular set of communication system data with a confidence value of 45%.

In some embodiments, the central server 122 may also receive the response database entries in addition to the communication system data and/or the user query. In these embodiments, the machine learning chatbot 122b2 may output the query response based upon the communication system data and/or the user query and the response database entries. The machine learning chatbot 122b2 may generally utilize the response database entries as a basis for comparison with the data interpreted from the communication system data and/or the user query to generate a more accurate, relevant query response. For example, the machine learning chatbot 122b2 may receive the communication system data and/or the user query, and in some embodiments, may extract/retrieve one or more embeddings from the communication system data and/or the user query. The machine learning chatbot 104b2 may then compare these embeddings to embeddings of the response database entries to identify prior query responses that may have addressed a similar user query and/or were based on similar communication system data, and may generate the query response based, in part, on the response database entries.

Additionally, in certain circumstances, the machine learning chatbot 122b2 may receive the communication system data and/or the user query and the user profile data. In these circumstances, the machine learning chatbot 122b2 may generate a query response that includes accurate, relevant data, while accounting for the user preferences contained within the user profile data. For example, the machine learning chatbot 122b2 may receive a user query indicating that a first user desires to process an insurance claim and may receive/access/retrieve communication system data corresponding to insurance claims. The machine learning chatbot 122b2 may thereafter retrieve user profile data of the first user, and may interpret the user profile data to determine that the first user typically prefers short, succinct conversations. Consequently, the machine learning chatbot 122b2 may generate query responses that are intended to provide as much relevant information as possible while allowing the first user to terminate the communication as quickly as possible, in accordance with the user profile data.

Moreover, in certain embodiments, the central server 122 may receive subsequent communication system data that supersedes, corrects, and/or otherwise changes the information/data included in prior communication system data. In response, the machine learning chatbot 122b2 may determine an updated response to subsequent user queries requesting information that may be, include, and/or otherwise reference the subsequent communication system data. The machine learning chatbot 122b2 may then generate the updated response to subsequent user queries requesting the information that may be, include, and/or otherwise reference the subsequent communication system data, and may cause the updated response to be conveyed to the user.

For example, a first set of communication system data (e.g., an operation manual) corresponding to a first communication system component (e.g., communication system component 112) may indicate a first solution to a common problem experienced by the first communication system component. However, due to a software/hardware update and/or any other suitable reason(s), this first solution may no longer adequately resolve the common problem for the first communication system component. The central server 122 may receive/retrieve a second set of communication system data (e.g., an email exchange between workstations 110) indicating that the common problem for the first communication system component may be adequately resolved by applying a second solution. The machine learning chatbot 122b2 may analyze this second set of communication system data, and may determine an updated response to queries corresponding to the common problem with the first communication system component based on the second solution indicated in the second set of communication system data. Consequently, the machine learning chatbot 122b2 may provide the updated response featuring the second solution to subsequent user queries requesting solutions to resolve the common problem with the first communication system component.

FIG. 2B, depicts a second exemplary workflow 220 for data input/output of a computing device (e.g., the central server 104) of FIG. 1, in accordance with various embodiments described herein. In particular, the second exemplary workflow 220 broadly illustrates an example query response generation sequence, in which the machine learning chatbot 122b2 may receive a user query and/or communication system data as inputs, determine/extract embeddings from the inputs, compare those embeddings to an embedding dictionary 226 and/or response database entries from the response database 104b5, and generate the query response. In certain embodiments, the machine learning chatbot 122b2 may receive the user query and/or the communication system data while the chatbot 122b2 is connected to a live communication channel, and the chatbot 122b2 may perform the actions illustrated by the query response generation sequence while the chatbot 122b2 remains connected to the live communication channel. Of course, this query response generation sequence illustrated in FIG. 2B is for the purposes of discussion only, and additional/alternative query response generation sequences utilizing additional/alternative machine learning techniques may also be utilized.

At a first time instance 222, the machine learning chatbot 122b2 may receive a user query and/or communication system data, as described herein. Both the user query and the communication system data may typically include a character string and/or a data sequence that may be converted to a text/character string representing data for processing by the machine learning chatbot 122b2. For example, the user query may include data from an external device (e.g., user device 106) that is provided by a user in the form of a question or other prompt corresponding to a subsystem/component of the communication system. Additionally, or alternatively, the user query and/or the communication system data may include written/transcribed natural language from a user/operator/live agent. This natural language included in the user query and/or the communication system data may also, for example, represent data related to/taken from the response database entries, user profile data, and/or other user input(s) that may influence the resulting query response output by the machine learning chatbot 122b2.

As one example, the user query may represent a question related to a first communication system subsystem and the communication system data may be or include data corresponding to the first communication system subsystem. The user query may also include an indication that the user has determined that the question is not related to a first or a second component of the first communication system subsystem. Thus, the machine learning chatbot 122b2 may utilize the user query, communication system data, and the user input to focus the determination of predicted query response(s) for the user query by eliminating the first and second components as potential components that may likely factor into the query response(s).

When the machine learning chatbot 122b2 receives the user query and the communication system data, the machine learning chatbot 122b2 may then proceed to interpret the user query and the communication system data in a manner consistent with the machine learning techniques used to train the chatbot 122b2, as discussed herein. As illustrated in FIG. 2B, one such interpretation may be to segment the user query and communication system data into various character strings that have corresponding embeddings. Individual words, data sequences, and/or other character sets may have or receive particular embeddings that represent an n-dimensional value, where each coordinate value or “item” of the embedding may be associated with a particular characteristic of the character set, and n may be any suitable integer value. For example, embedding A may be an n-dimensional value corresponding to a first character set in the user query and the communication system data, embedding B may be an n-dimensional value corresponding to a second character set in the user query and the communication system data, and embedding N may be an n-dimensional value corresponding to a last character set in the user query and the communication system data. In any event, the machine learning chatbot 122b2 may generate a set of embeddings for some/all of the data included as part of the user query and the communication system data.

At a second time instance 224, the machine learning chatbot 122b2 may compare each of the embeddings to an embedding dictionary 226 to determine associations between the user query and the communication system data and similar user queries and communication system data, and by proxy, corresponding query responses associated with those similar user queries and communication system data. More specifically, the machine learning chatbot 122b2 may reference the embeddings stored in the embedding dictionary 226 to determine embeddings that are “close” to the embeddings of the user query and the communication system data. This measure of closeness may be determined by calculating, for example, a geometric distance between two embeddings within the corresponding n-dimensional space. Each embedding may be compared to the embeddings in the embedding dictionary 226 in this manner, and the machine learning chatbot 122b2 may determine one or more embeddings from the dictionary 226 that are the closest to the embeddings from the user query and the communication system data.

In certain embodiments, the embeddings in the embedding dictionary 226 may be associated with prior user queries, prior communication system data, and/or prior query responses, such as those stored in the response database 104b5. Namely, the embedding dictionary 226 may include and/or reference a storage location where the associated prior user queries, prior communication system data, and/or prior query responses are stored to enable the machine learning chatbot 122b2 to reference and/or otherwise utilize these prior user queries, prior communication data, and/or prior query responses when generating a new query response based upon an input user query and the communication system data. The machine learning chatbot 122b2 may thereby determine that embeddings from a user query and the communication system data that are relatively close (in the n-dimensional space) to a first set of embeddings in the embedding dictionary 226 may be associated with a similar user query, communication system data, query response, communication system subsystem/component, and/or other data.

Consequently, the machine learning chatbot 122b2 may generate a query response that includes predicted query response(s) based upon the comparison of the embeddings from the user query and the communication system data to the embedding dictionary 226. For example, the machine learning chatbot 122b2 may determine that the embeddings from the user query and the communication system data are relatively close (in the n-dimensional space) to embeddings in the embedding dictionary 226 that are associated with a first query response and a first communication system data corresponding to a first communication system subsystem/component. The machine learning chatbot 122b2 may then access prior user queries, prior communication system data, and/or prior query responses corresponding to the first user query, the first communication system data, and/or the first communication system subsystem/component to determine a query response that most accurately reflects the circumstances indicated in the user query included in the first user query and the first communication system data.

As mentioned, the actions described herein in reference to the second exemplary workflow 220 may occur while the machine learning chatbot 122b2 is connected to a live communication channel. For example, the user query may be received from a user communicating with the communication system through a network (e.g., network 116) and across a live webchat, a phone call, an email, a text message, a video call, and/or any other suitable communication channel(s) or combinations thereof. Similarly, the communication system data may be retrieved/accessed/received (e.g., from the workstation 110, memory 104b, communication system component 112, user device 106) by the machine learning chatbot 122b2 while the chatbot 122b2 is connected to the live communication channel. The machine learning chatbot 122b2 may analyze the user query and the communication system data, as described herein, and may generate a query response in real-time or substantially real-time while the chatbot 122b2 remains connected to the live communication channel. Thus, the user/operator/live agent connected to the live communication channel with the machine learning chatbot 122b2 may view/review the query response in real-time during the live communication. In this manner, the machine learning chatbot 122b2 may function as an interactive knowledge base that users/operators/live agents may leverage during the live communication to receive accurate, real-time, up-to-date communication system information.

### Exemplary Graphical User Interfaces (GUIs)

FIG. 3 depicts an exemplary graphical user interface (GUI) 300 that may be displayed on a computing device (e.g., workstation 110 of FIG. 1), in accordance with various embodiments described herein. Generally, the exemplary GUI 300 may allow a user (e.g., a live agent or operator) to interact with the central server 104, which may include receiving outputs from the central server 104 or sending inputs to the central server 104, as described in reference to the first exemplary workflow 200 of FIG. 2A. The exemplary GUI 300 thus provides the user with a designated place to remain informed regarding the functioning of a communication system configured to establish, maintain, and perform communication activities between/among various devices (e.g., user device 106). In particular, the exemplary GUI 300 may display information, values, maps, contact information, and/or other data related to user queries, communication system data, and/or query responses corresponding to and/or otherwise associated with subsystems/components of a communication system.

Namely, the exemplary GUI 300 may include a query display hub 312, a proposed query response hub 318, and a knowledgebase hub 320. The query display hub 312 may include a predicted user query resolution indication 313, a predicted user query resolution value 314, and a communication system data access button 315. The user may directly interact (e.g., click, swipe, tap, gesture, voice command, etc.) with the communication system data access button 315 to initiate additional actions that may direct the user away from the exemplary GUI 300.

For example, interacting with the communication system data access button 315 may cause the workstation 110 to load and render and/or otherwise cause the user to view one or more documents, files, communications, and/or any other suitable data or combinations thereof related to the communication system component(s)/subsystem(s) and/or other objects or concepts (e.g., an insurance policy) indicated in the user query. The user/operator/live agent may view the communication system data on the workstation 110 (or user device 106) display, and in certain embodiments, the relevant portions of the communication system data may be highlighted and/or otherwise marked for specific reference by the user. In this manner, the user/operator/live agent may direct their attention to the relevant portions of the communication system data that may have influenced the query response provided in the proposed query response hub 318. The user/operator/live agent may read the communication system data, and may independently validate the information provided in the query response and/or otherwise check that the machine learning chatbot 122b2 is accessing/referencing relevant information when generating query responses for a particular subsystem/component of the communication system and/or other objects or concepts, about which, a user/operator/live agent may provide a user query.

The predicted user query resolution indication 313 and predicted user query resolution value 314 may generally correspond to an estimated time required to resolve the query indicated in the user query. In this manner, an operator (e.g., a live agent) may view the predicted user query resolution value 314 and understand approximately how long the user query may take to resolve. In certain embodiments, the predicted user query resolution value 314 may be based upon prior query resolution times for identical/similar user queries.

Generally speaking, the proposed query response hub 318 and the knowledgebase hub 320 may provide instructions, values, recommendations, and/or other indications to a user/operator/live agent related to data processed by the central server 104. For example, as illustrated in FIG. 3, the proposed query response hub 318 provides the “[u]ser [q]uery: “XXXXXXXX”, and a “[p]roposed [r]esponse: XXXXXXX”. The user/operator/live agent may view the predicted query response(s) in the proposed query response hub 318, and the user/operator/live agent may enable the machine learning chatbot 122b2 to continue communication with the user (e.g., of user device 106) and/or provide user input regarding the query response, as described herein.

As yet another example, and as illustrated in FIG. 3, the knowledgebase hub 320 states that “[t]he user query indicates that the user likely desires information relating to a first audio component. The interactive knowledge base has determined that the likely answer to the user query involves actions X, Y, and Z. This information can be located in the communication system data at page XX.” The machine learning chatbot 122b2 may generate such a proposed response rationale summary to quickly educate a user/operator/live agent regarding the underlying rationale for the proposed response featured in the proposed query response hub 318. The user/operator/live agent may view the proposed response rationale summary in the knowledgebase hub 320, and the user may evaluate how accurately the machine learning chatbot 122b2 has analyzed/interpreted and/or responded to the user query. In this manner, the user/operator/live agent may determine whether the machine learning chatbot 122b2 should be updated/re-trained, and/or whether the user/operator/live agent should use and/or rely on the information provided in the proposed response displayed in the proposed query response hub 318.

Moreover, it should be understood that any user query data, communication system subsystem/component data, and/or any values determined, detected, calculated, and/or otherwise output by the central server 104 may be displayed generally in the exemplary GUI 300. Additionally, or alternatively, it should be appreciated that interaction with any of the hubs or other displays in the exemplary GUI 300 may cause the workstation 110, the user device 106, and/or the central server 104 to perform other actions than those described in reference to FIG. 3. As such, other actions/signals described herein may be transmitted, relayed, and/or otherwise performed by the workstation 110, user device 106, and/or the central server 104 in response to a user interacting with any hub or display within the exemplary GUI 300.

### Exemplary Computer-Implemented Methods

FIG. 4 depicts a flow diagram representing an exemplary computer-implemented method 400, in accordance with various embodiments described herein. The method 400 may be implemented by one or more processors of the exemplary computing system 100, such as the central server 104, the workstation 110, the user device 106, the communication system component 112, the external server 114, and/or any other suitable components described herein or combinations thereof.

The method 400 may include connecting a training module configured to train a machine learning chatbot to a communication channel associated with the communication system (block 402). The communication channel may transmit data corresponding to the communication system. The method 400 may further include aggregating, by executing the training module, a set of data corresponding to the communication system from a plurality of communications utilizing the communication channel (block 404).

The method 400 may further include training, by executing the training module, the machine learning chatbot with the set of data corresponding to the communication system as inputs to generate a plurality of training responses as outputs (block 406). The plurality of training responses may represent responses to hypothetical prompts related to the data corresponding to the communication system. The method 400 may further include connecting the machine learning chatbot to one or more live communication channels of the communication system to generate predicted responses to live prompts received across the one or more live communication channels (block 408). The method 400 may include additional, less, or alternate functionality and actions, including those discussed elsewhere herein.

For example, in certain embodiments, the method 400 may further include connecting a user to a live agent across a first communication channel to which the machine learning chatbot is connected (block 410). Further in these embodiments, the method 400 may further include receiving a user query from the user (block 412); and/or generating, by executing the machine learning chatbot, a predicted response to the user query, wherein the predicted response includes a citation to a first piece of data from the set of data (block 414).

Further in these embodiments, generating the predicted response may further include generating one or more embeddings associated with the user query; comparing the one or more embeddings to a library of embeddings; and/or determining the predicted response based on the comparing. Still further in these embodiments, generating the predicted response may further include retrieving one or more prior responses from a response database; evaluating, by executing the machine learning chatbot, a predicted relevance of the one or more prior responses based on the user query; determining, by executing the machine learning chatbot, at least one relevant prior response from the one or more prior responses; and/or generating, by executing the machine learning chatbot, the predicted response based on the user query and the at least one relevant prior response.

In some embodiments, the set of data corresponding to the communication system may be a first set of data, and the method 400 may further include: aggregating a second set of data corresponding to the communication system from a plurality of internal subsystems of the communication system, wherein the second set of data includes one or more of: (i) an internal document, (ii) an archived email, (iii) a recorded verbal conversation, or (iv) a recorded live chat; and/or re-training, by executing the training module, the machine learning chatbot with the second set of data.

In certain embodiments, the communication channel may be at least one of: (i) a live webchat, (ii) a phone call, (iii) an email, (iv) a text message, and/or (v) a video call; and/or the set of data corresponding to the communication system may include one or more of: (i) a text string, (ii) an audio stream, (iii) a video stream, (iv) a file, and/or (v) a document.

In some embodiments, the one or more live communication channels may include an audio communication channel, and the method 400 may further include: receiving a verbal communication across the audio communication channel; converting the verbal communication to a first text string; determining, by executing the machine learning chatbot, a first predicted response to the verbal communication based on the first text string; generating, by executing the machine learning chatbot, the first predicted response to the verbal communication as a second text string; converting the second text string to a second verbal communication; and/or causing the second verbal communication to be conveyed across the audio communication channel.

Of course, it is to be appreciated that the actions of the method 400 may be performed any suitable number of times, and that the actions described in reference to the method 400 may be performed in any suitable order.

### ADDITIONAL CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The systems and methods described herein are directed to an improvement to computer functionality, and improve the functioning of conventional computers. Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still cooperate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

Upon reading this disclosure, those of skill in the art will appreciate still additional alternative structural and functional designs for evaluation properties, through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed is:

1. A computer-implemented method for creating an interactive knowledge base in a communication system, the method comprising:
connecting, by one or more processors, a training module configured to train a machine learning (ML) chatbot to a communication channel associated with the communication system, wherein the communication channel transmits data corresponding to the communication system;
aggregating, by the one or more processors executing the training module, a set of data corresponding to the communication system from a plurality of communications utilizing the communication channel;
training, by the one or more processors executing the training module, the ML chatbot with the set of data corresponding to the communication system as inputs to generate a plurality of training responses as outputs, wherein the plurality of training responses represents responses to hypothetical prompts related to the data corresponding to the communication system; and
connecting, by the one or more processors, the ML chatbot to one or more live communication channels of the communication system to generate predicted responses to live prompts received across the one or more live communication channels.

2. The computer-implemented method of claim 1, further comprising:
connecting, by the one or more processors, a user to a live agent across a first communication channel to which the ML chatbot is connected;
receiving, at the one or more processors, a user query from the user; and
generating, by the one or more processors executing the ML chatbot, a predicted response to the user query, wherein the predicted response includes a citation to a first piece of data from the set of data.

3. The computer-implemented method of claim 2, wherein generating the predicted response further comprises:
generating, by the one or more processors, one or more embeddings associated with the user query;
comparing, by the one or more processors, the one or more embeddings to a library of embeddings; and
determining, by the one or more processors, the predicted response based on the comparing.

4. The computer-implemented method of claim 2, wherein generating the predicted response further comprises:
retrieving, by the one or more processors, one or more prior responses from a response database;
evaluating, by the one or more processors executing the ML chatbot, a predicted relevance of the one or more prior responses based on the user query;
determining, by the one or more processors executing the ML chatbot, at least one relevant prior response from the one or more prior responses; and
generating, by the one or more processors executing the ML chatbot, the predicted response based on the user query and the at least one relevant prior response.

5. The computer-implemented method of claim 1, wherein the set of data corresponding to the communication system is a first set of data, and the method further comprises:
aggregating, by the one or more processors, a second set of data corresponding to the communication system from a plurality of internal subsystems of the communication system, wherein the second set of data includes one or more of: (i) an internal document, (ii) an archived email, (iii) a recorded verbal conversation, or (iv) a recorded live chat; and
re-training, by the one or more processors executing the training module, the ML chatbot with the second set of data.

6. The computer-implemented method of claim 1, wherein:
the communication channel is at least one of: (i) a live webchat, (ii) a phone call, (iii) an email, or (iv) a text message; and
the set of data corresponding to the communication system includes one or more of: (i) a text string, (ii) an audio stream, (iii) a video stream, (iv) a file, or (v) a document.

7. The computer-implemented method of claim 1, wherein the one or more live communication channels includes an audio communication channel, and the method further comprises:
receiving, at the one or more processors, a verbal communication across the audio communication channel;
converting, by the one or more processors, the verbal communication to a first text string;
determining, by the one or more processors executing the ML chatbot, a first predicted response to the verbal communication based on the first text string;
generating, by the one or more processors executing the ML chatbot, the first predicted response to the verbal communication as a second text string;
converting, by the one or more processors, the second text string to a second verbal communication; and
causing, by the one or more processors, the second verbal communication to be conveyed across the audio communication channel.

8. A system for creating an interactive knowledge base in a communication system, comprising:
one or more processors; and
a non-transitory computer-readable memory coupled to the one or more processors and the user interface, the memory storing instructions thereon that, when executed by the one or more processors, cause the one or more processors to:
connect a training module configured to train a machine learning (ML) chatbot to a communication channel associated with the communication system, wherein the communication channel transmits data corresponding to the communication system,
aggregate, by executing the training module, a set of data corresponding to the communication system from a plurality of communications utilizing the communication channel,
train, by executing the training module, the ML chatbot with the set of data corresponding to the communication system as inputs to generate a plurality of training responses as outputs, wherein the plurality of training responses represents responses to hypothetical prompts related to the data corresponding to the communication system, and
connect the ML chatbot to one or more live communication channels of the communication system to generate predicted responses to live prompts received across the one or more live communication channels.

9. The system of claim 8, wherein the instructions, when executed, further cause the one or more processors to:
connect a user to a live agent across a first communication channel to which the ML chatbot is connected;
receive a user query from the user; and
generate, by executing the ML chatbot, a predicted response to the user query, wherein the predicted response includes a citation to a first piece of data from the set of data.

10. The system of claim 9, wherein the instructions, when executed, further cause the one or more processors to generate the predicted response by:
generating one or more embeddings associated with the user query;
comparing the one or more embeddings to a library of embeddings; and
determining the predicted response based on the comparing.

11. The system of claim 9, wherein the instructions, when executed, further cause the one or more processors to generate the predicted response by:
retrieving one or more prior responses from a response database;
evaluating, by executing the ML chatbot, a predicted relevance of the one or more prior responses based on the user query;
determining, by executing the ML chatbot, at least one relevant prior response from the one or more prior responses; and
generating, by executing the ML chatbot, the predicted response based on the user query and the at least one relevant prior response.

12. The system of claim 8, wherein the set of data corresponding to the communication system is a first set of data, and the instructions, when executed, further cause the one or more processors to:
aggregate a second set of data corresponding to the communication system from a plurality of internal subsystems of the communication system, wherein the second set of data includes one or more of: (i) an internal document, (ii) an archived email, (iii) a recorded verbal conversation, or (iv) a recorded live chat; and
re-train, by executing the training module, the ML chatbot with the second set of data.

13. The system of claim 8, wherein:
the communication channel is at least one of: (i) a live webchat, (ii) a phone call, (iii) an email, or (iv) a text message; and
the set of data corresponding to the communication system includes one or more of: (i) a text string, (ii) an audio stream, (iii) a video stream, (iv) a file, or (v) a document.

14. The system of claim 8, wherein the one or more live communication channels includes an audio communication channel, and the instructions, when executed, further cause the one or more processors to:
receive a verbal communication across the audio communication channel;
convert the verbal communication to a first text string;
determine, by executing the ML chatbot, a first predicted response to the verbal communication based on the first text string;
generate, by executing the ML chatbot, the first predicted response to the verbal communication as a second text string;
convert the second text string to a second verbal communication; and
cause the second verbal communication to be conveyed across the audio communication channel.

15. A tangible machine-readable medium comprising instructions for creating an interactive knowledge base in a communication system that, when executed, cause a machine to at least:
connect a training module configured to train a machine learning (ML) chatbot to a communication channel associated with the communication system, wherein the communication channel transmits data corresponding to the communication system;
aggregate, by executing the training module, a set of data corresponding to the communication system from a plurality of communications utilizing the communication channel;
train, by executing the training module, the ML chatbot with the set of data corresponding to the communication system as inputs to generate a plurality of training responses as outputs, wherein the plurality of training responses represents responses to hypothetical prompts related to the data corresponding to the communication system; and
connect the ML chatbot to one or more live communication channels of the communication system to generate predicted responses to live prompts received across the one or more live communication channels.

16. The tangible machine-readable medium of claim 15, wherein the instructions, when executed, further cause the machine to at least:
connect a user to a live agent across a first communication channel to which the ML chatbot is connected;
receive a user query from the user; and
generate, by executing the ML chatbot, a predicted response to the user query, wherein the predicted response includes a citation to a first piece of data from the set of data.

17. The tangible machine-readable medium of claim 16, wherein the instructions, when executed, further cause the machine to at least generate the predicted response by:
generating one or more embeddings associated with the user query;
comparing the one or more embeddings to a library of embeddings; and
determining the predicted response based on the comparing.

18. The tangible machine-readable medium of claim 16, wherein the instructions, when executed, further cause the machine to at least generate the predicted response by:
retrieving one or more prior responses from a response database;
evaluating, by executing the ML chatbot, a predicted relevance of the one or more prior responses based on the user query;
determining, by executing the ML chatbot, at least one relevant prior response from the one or more prior responses; and
generating, by executing the ML chatbot, the predicted response based on the user query and the at least one relevant prior response.

19. The tangible machine-readable medium of claim 15, wherein the set of data corresponding to the communication system is a first set of data, and the instructions, when executed, further cause the machine to at least:
aggregate a second set of data corresponding to the communication system from a plurality of internal subsystems of the communication system, wherein the second set of data includes one or more of: (i) an internal document, (ii) an archived email, (iii) a recorded verbal conversation, or (iv) a recorded live chat; and
re-train, by executing the training module, the ML chatbot with the second set of data.

20. The tangible machine-readable medium of claim 15, wherein:
the communication channel is at least one of: (i) a live webchat, (ii) a phone call, (iii) an email, or (iv) a text message; and
the set of data corresponding to the communication system includes one or more of: (i) a text string, (ii) an audio stream, (iii) a video stream, (iv) a file, or (v) a document.
